(19) United States
(12) Patent Application Publication
(10) Pub. No.: US 2011/0177346 A1
(43) Pub. Date: Jul. 21, 2011

(54) METHOD OF IMPARTING CORROSION RESISTANCE TO A SUBSTRATE COATED WITH A POWDER COATING COMPOSITION

(76) Inventors: Nathan J. Silvernail, Allison Park, PA (US); Margaret L. MacKay, East Palestine, OH (US)

(21) Appl. No.: 12/688,125

(22) Filed: Jan. 15, 2010

(51) Int. Cl. B32B 15/095; B05D 1/36; B05D 1/38

(52) U.S. Cl. 428/425.8; 427/202

(57) ABSTRACT

The present invention is directed to a method for coating a substrate with a variety of coating compositions thereby imparting corrosion resistance properties to the substrate. In some embodiments, the method comprises: (a) depositing a pretreatment coating composition, which comprises zirconium, onto at least a portion of a substrate; (b) depositing a powder coating composition onto at least a portion of the pretreatment coating composition; and (c) curing at least a portion of the powder coating composition.

The United States Government may have certain rights to this invention pursuant to Contract No. W15QKN-07-C-0048 awarded by the Armament Research, Development and Engineering Center (“ARDEC”).

### FIELD OF THE INVENTION

The present invention relates to a method of imparting corrosion resistance to a substrate coated with a powder coating composition.

### BACKGROUND INFORMATION

Phosphate based pretreatment coating compositions have been traditionally used to enhance the corrosion resistance of substrates onto which they have been applied. Increasing environmental awareness, governmental regulations, and costs, however, are placing operational limits on the use of such coatings in the industrial setting.

Powder coatings are an environmentally friendly alternative to liquid paint technologies due to the nearly total elimination of hazardous wastes and solvent emissions during application and curing. In addition, the approximately 95% material transfer efficiency of powder coatings greatly reduces product waste. Powder coatings give additional cost benefits related to the vast reduction in required air-handling equipment and labor costs associated with paint bath chemistry modification and part reworks.

Prior to the application of powder coatings, phosphate based pretreatment coating compositions have been traditionally used to enhance the corrosion resistance of substrates onto which they have been applied. Increasing environmental awareness, governmental regulations, and costs, however, are placing operational limits on the use of such coatings in the industrial setting.

### SUMMARY OF THE INVENTION

A coating system comprising: a first coating layer deposited onto at least a portion of a substrate wherein the first coating layer is deposited from a first coating composition comprising: a group IIIB metal compound, a group IVB metal compound, or combinations thereof; and a second coating layer deposited onto at least a portion of the first coating layer wherein the second coating layer is deposited from a second coating composition comprising a powder coating composition.

A coating system comprising: a first coating layer deposited onto at least a portion of a substrate wherein said first coating layer is deposited from a first coating composition comprising a group IIIB metal compound, a group IVB metal compound, or combinations thereof; and a second coating layer deposited onto at least a portion of the first coating layer wherein the second coating layer is deposited from a second coating composition comprising a powder coating composition; and wherein the coating system demonstrates a scribe loss value of at least 2.4 mm less, when subjected to the Neutral Salt Spray Test, than that of a coating system in which the first coating layer does not comprise a group IIIB metal compound, a group IVB metal compound, or combinations thereof; and wherein the dry film thickness of the powder coating layer is ≦2 mil.

A method of coating a substrate comprising: depositing a first coating composition onto at least a portion of the substrate, the first coating composition comprising: a group IIIB metal compound, a group IVB metal compound, or combinations thereof; optionally, rinsing at least a portion of the first coating composition with an rinsing solution; and depositing a second coating composition onto at least a portion of the first coating composition, the second coating composition comprising a powder coating composition.

### DETAILED DESCRIPTION

As used herein, unless otherwise expressly specified, all numbers such as those expressing values, ranges, amounts or percentages may be read as if prefaced by the word “about”, even if the term does not expressly appear. When referring to any numerical range of values, such ranges are understood to include each and every number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10. As employed herein, the term “number” means one or an integer greater than one.

As used herein, plural phrases or terms encompasses their singular counterparts and vice versa, unless specifically stated otherwise. By way of illustration, and not limitation, although reference is made herein to “a” soluble rare earth metal, a plurality of these rare earth metals may be used in the present invention. As used herein, “plurality” means two or more.

As used herein, “includes” and like terms means “including without limitation.”

As used herein, the use of “or” means “and/or” unless specifically stated otherwise, even though “and/or” may be explicitly used in certain instances.

As used herein, “molecular weight” means weight average molecular weight (Mw) as determined by Gel Permeation Chromatography.

Unless otherwise indicated, as used herein, “substantially free” means that a composition comprises ≦1 weight percent, such as ≦0.8 weight percent or ≦0.5 weight percent or ≦0.05 weight percent or ≦0.005 weight percent, of a particular material (e.g., organic solvent, filler, etc . . . ) based on the total weight of the composition.

Unless otherwise indicated, as used herein, “completely free” means that a composition does not comprise a particular material (e.g., organic solvent, filler, etc . . . ). That is, the composition comprises 0 weight percent of such material.

Unless otherwise indicated, as used herein, “substantially free” means that a composition comprises ≦1 weight percent, such as ≦0.8 weight percent or ≦0.5 weight percent or ≦0.05 weight percent or ≦0.005 weight percent, of a particular material (e.g., organic solvent, filler, etc . . . ) based on the total weight of the composition.

Unless otherwise indicated, as used herein, “completely free” means that a composition does not comprise a particular material (e.g., organic solvent, filler, etc . . . ). That is, the composition comprises 0 weight percent of such material.

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

Reference to any monomer(s) herein refers generally to a monomer that can be polymerized with another polymerizable component such as another monomer or polymer. Unless otherwise indicated, it should be appreciated that once the monomer components react with one another to form a compound, the compound will comprise the residues of the monomer components.

### Method of Coating a Substrate

The present invention is directed to a method of applying various coating compositions onto a surface of substrate that may impart protective, such as corrosion resistance, and decorative properties to the substrate. The present invention is also directed to substrate coated with a coating system deposited from such coating compositions. It was found that, in some embodiments, corrosion resistant properties were maintained even when a topcoat layer, such as coating layer that is deposited from the second coating composition described below, had a reduced film thickness. In certain embodiments, the corrosion resistant properties were observed when the coating layer's film thickness was ≦50.8 microns (2 mil), such as ≦25.4 microns (1 mil) or ≦1.27 microns (0.5 mil).

The method disclosed herein comprises: (1) depositing a first coating composition onto at least a portion of the substrate (e.g., a surface of a substrate); (2) optionally, rinsing at least a portion of the first coating composition with an rinsing solution; (3) optionally, subjecting at least a portion of the first coating composition or, alternatively, the aqueous solution to a drying step; and (4) depositing a second coating composition onto at least a portion of the first coating composition. The first coating composition comprises a group IIIB metal compound, a group IVB metal compound, or combinations thereof while the second coating composition comprises a powder coating composition. After the second coating composition is deposited onto the first coating composition, the second coating composition is cured using techniques well known in the art.

The substrate to be coated in accordance with the methods of the present invention may first be cleaned to remove grease, dirt, or other extraneous matter using techniques known in the art. For example, mild or strong alkaline cleaners, which are commercially available and conventionally used in metal pretreatment processes, can be used to clean at least a portion of the surface of the substrate. Examples of alkaline cleaners suitable for use in the present invention include CHEMKLEEN 163 and CHEMKLEEN 177, both of which are commercially available from PPG Industries, Inc. Such cleaners are often followed and/or preceded by a rinsing step in which a rinsing solution, such as water (including deionized water), is applied onto the substrate.

In some embodiments, the rinsing solution is subjected to a drying step in order to remove any excess coating composition and/or water from the substrate. Any suitable method known in the art to may be employed to conduct the drying step. In some embodiments, the method for conducting the drying step includes exposing the surface to be dried with forced air, which is at a temperature of 60° C. (140° F.), for a time ranging from 10 seconds to 2 minutes.

### First Coating Composition:

As described above, the method of the present invention entails depositing a first coating composition onto at least a portion of the substrate. As used herein, the first coating composition is not a coating that is cured to form a continuous layer on a substrate (e.g., a basecoat or clearcoat). Rather, it is a pretreatment composition. As used herein, “pretreatment coating composition” refers to a composition that chemically alters the surface of a bare metal substrate. For example, in some embodiments, the pretreatment composition deposits an oxide, such as zirconium oxide, onto the surface of the metal substrate. The first coating composition comprises a group IIIB metal, a group IVB metal, or combinations thereof. In certain embodiments, the first coating composition is free of copper. As used herein, the terms “group IIIB metal” and “group IVB metal” refer to the elements that are in group IIIB and group IVB of the CAS Periodic Table of Elements as shown, for example in the Handbook of Chemistry and Physics, 63rd edition (1983). As used herein, the term “group IIIB metal compound” or “group IVB metal compound” refers to compounds that comprise at least one element that is in group IIIB or group IVB of the CAS Periodic Table of Elements. While, in certain embodiments, the source of the IIIB and/or IVB metal is the metal itself (e.g., zirconium, titanium, hafnium, yttrium, cerium, or combinations thereof), group IIIB and/or IVB compounds may also be used as the source of the IIIB and/or IVB metal. Suitable IIIB and/or IVB compounds include hexafluorozirconic acid, alkali metal and ammonium salts thereof, ammonium zirconium carbonate, zirconyl nitrate, zirconium carboxylates and zirconium hydroxy carboxylates, such as hydrofluorozirconic acid, zirconium acetate, zirconium oxalate, ammonium zirconium glycolate, ammonium zirconium lactate, ammonium zirconium citrate, fluorotitanic acid and its salts, hafnium nitrate, yttrium nitrate, cerous nitrate, or combinations thereof.

In certain embodiments, the group IIIB and/or group IVB metal compound is present in the first coating composition in an amount of 10 to 5000 parts per million (“ppm”) metal, such as 100 to 300 ppm metal, based on the total weight of the first coating composition. The pH of the first coating composition often ranges from 2.0 to 7.0, such as 3.5 to 5.5. The pH of the first coating composition may be adjusted using mineral acids, such as hydrofluoric acid, fluoroboric acid, phosphoric acid, and the like, including mixtures thereof; organic acids, such as lactic acid, acetic acid, citric acid, or mixtures thereof; and water soluble or water dispersible bases, such as sodium hydroxide, ammonium hydroxide, ammonia, or amines, such as triethylamine, methylethyl amine, diisopropanolamine, or a mixture thereof.

While in certain embodiments the first coating composition is free of copper, in other embodiments, however, the first coating composition can comprise copper. In some embodiments, the source of copper in the first coating composition can be the metal itself (e.g., both water soluble and insoluble copper compounds). As used herein, “copper compound” refers to compounds that comprise copper. Suitable water soluble and/or water insoluble copper compounds include copper cyanide, copper potassium cyanide, copper sulfate, copper nitrate, copper pyrophosphate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper formate, copper acetate, copper propionate, copper butyrate, copper lactate, copper oxalate, copper phytate, copper tartarate, copper malate, copper succinate, copper malonate, copper maleate, copper benzoate, copper salicylate, copper aspartate, copper glutamate, copper fumarate, copper glycerophosphate, sodium copper chlorophyllin, copper fluorosilicate, copper fluoroborate and copper iodate, as well as copper salts of carboxylic acids in the homologous series formic acid to decanoic acid, copper salts of polybasic acids in the series oxalic acid to suberic acid, and copper salts of hydroxycarboxylic acids, including glycolic, lactic, tartaric, malic and citric acids, or combinations in any of the foregoing. In certain embodiments, the copper compound is added as a complex salt such as those described in U.S. Patent Publication No. 2009/0084682 in paragraph [0020], the cited portion of which being incorporated herein by reference.

Certain sources of a water-soluble copper compounds may cause precipitation in the form of an impurity, such as copper sulfate, copper oxide, etc., when these sources are used. It, therefore, may be desirable to add a complexing agent that suppresses the precipitation of copper ions, thus stabilizing them as a copper complex in the solution. Suitable complexing agents include those described in U.S. Patent Publication No. 2009/0084682 in paragraph [0021], the cited portion of which being incorporated herein by reference.

In certain embodiments, copper is included in the first coating composition in an amount from 1 ppm to 5,000 ppm, such as 1 ppm to 500 ppm, or, in some cases, 1 ppm to 50 ppm of total copper (measured as elemental copper), based on the total weight of the ingredients in the first coating composition.

In some embodiments, the first coating composition can also comprise the various materials, such as the binder, and surfactants as described in paragraphs [0025] to [0028] of United States Patent Application Publication No. 2008/0145678, which is incorporated herein by reference.

In certain embodiments, the first coating composition also comprises a silane, such as, for example, an amino group-containing silane coupling agent, a hydrolysate thereof, or a polymer thereof, as described in paragraphs [0025] to [0031] of United States Patent Application Publication No. 2004/0163736, the cited portion of which being incorporated herein by reference. In other embodiments of the present invention, however, the first coating composition is substantially free, or, in some cases, completely free of any such amino group-containing silane coupling agent. As used herein, the term “substantially free”, when used with reference to the absence of amino-group containing silane coupling agent in the first coating composition, means that any amino-group containing silane coupling agent, hydrolysate thereof, or polymer thereof that is present in the pretreatment composition is present in an amount of less than 5 ppm.

In certain embodiments, the first coating composition also comprises a reaction accelerator, such as nitrite ions, nitro-group containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof, or combinations thereof. Specific examples of suitable materials and their amounts are described in United States Patent Application Publication No. 2004/0163736 in paragraphs [0032] to [0041], the cited portion of which being incorporated herein by reference.

In certain embodiments, the first coating composition also includes a source of phosphate ions. Suitable amounts of phosphate ions and suitable sources of such ions are described in U.S. Patent Application Publication No. 2009/0032144 in paragraph [0043], the cited portion of which being incorporated herein by reference. In other embodiments, however, the first coating composition is substantially or, in some cases, completely free of phosphate ions. As used herein, the term “substantially free” when used in reference to the absence of phosphate ions in the first coating composition, means that phosphate ion is present in the composition in an amount of less than 10 ppm based on the total weight of the first coating composition.

In certain embodiments, the first coating composition is substantially free or, in some cases, completely free of chromate and/or heavy metal phosphate, such as zinc phosphate.

Moreover, in certain embodiments, the first coating composition is substantially free, or, in some cases, completely free of any organic materials.

In some embodiments, the first coating composition further comprises (iii) free fluorine and (iv) a metal fluoride salt formed from a metal and/or metal compound which forms a fluoride salt. The metal that forms the metal fluoride salt is supplied or present in an amount sufficient to maintain the level of free fluorine in the first coating composition at a level ranging from 0.1 ppm to 300 ppm based on the total weight of the first coating composition. As used herein, “free fluorine” means isolated fluorine ion and its concentration in the first coating composition. Suitable sources of fluorine include those described in United States Patent Application Publication No. 2009/0032144 in paragraphs [0027] to [0028], the cited portion of which being incorporated herein by reference. In some embodiments, the metal fluoride salt that is formed has a pKsp of at least 11, such as at least 15 or at least 20. As used herein, “pKₛₚ” refers to the inverse log of the solubility product constant for a compound. In the present invention, a metal and/or metal containing compound is selected such that it forms a fluoride salt having a pKₛₚ of at least 11. For purposes of this invention, the pKₛₚ value for a metal fluoride salt refers to the pKₛₚ values reported in Lange's Handbook of Chemistry, 15th Ed., McGraw-Hill, 1999, Table 8.6. In certain embodiments, the metal and/or metal compound which forms a fluoride salt having a pKₛₚ of at least 11 is selected from cerium (pKₛₚ of CeF₃ is 15.1), lanthanum (pKₛₚ of LaF₃ is 16.2), scandium (pKₛₚ of ScF₃ is 23.24), yttrium (pKₛₚ of Y₃ is 20.06), or mixture thereof. In certain embodiments, the metal and/or metal compound can be present in the first coating composition in an amount ranging from 0.1 ppm to 300 ppm, such as from 20 ppm to 100 ppm.

In some embodiments, the first coating composition comprises a yttrium containing compound such as those described in U.S. Patent Application Publication No. 2009/0032144 in paragraph [0033], the cited portion of which being incorporated herein by reference.

Additionally, in certain embodiments, the first coating composition can comprise an “electropositive metal” as described in U.S. Patent Application Publication No. 2009/0084682 in paragraphs [0014] to [0015], the cited portion of which being incorporated herein by reference.

After application of the first coating composition on at least a portion of the substrate, the first coating composition can, optionally, be rinsed with water, such as deionized water. Alternatively, at least a portion of the first coating composition, immediately or after a drying period at ambient or elevated temperature conditions, may be coated with the second coating composition described below.

### Second Coating Composition:

As stated above, the present invention also includes the deposition of a second coating composition onto at least a portion of the first coating composition. The second coating composition is a powder coating composition. As used herein, “powder coating composition” refers to a coating composition which is completely free of water and/or solvent. Accordingly, the powder coating composition disclosed herein is not synonymous to waterborne and/or solventborne coating compositions known in the art.

does not include the various waterborne coating compositions and/or solventborne coating compositions that are known in the art of coating technology.

In certain embodiments, the powder coating composition comprises (a) a film forming polymer having a reactive functional group; and (b) a curing agent that is reactive with the functional group. Examples of powder coating compositions that may be used in the present invention include the ENVIROCRON line of powder coating compositions (commercially available from PPG Industries, Inc.) as well as the powder coating compositions described in U.S. Pat. Nos. 7,470,752, 7,432,333, and 6,797,387.

Suitable film forming polymers that may be used in the present invention comprise a (poly)ester (e.g., polyester triglycidyl isocyanurate), a (poly)urethane, an isocyanurate, a (poly)urea, a (poly)epoxy, an anhydride, an acrylic, a (poly)ether, a (poly)sulfide, a (poly)amine, a (poly)amide, (poly)vinyl chloride, (poly)olefin, (poly)vinylidene fluoride, or combinations thereof.

In certain embodiments, the reactive functional group of the film forming polymer comprises hydroxyl, carboxyl, isocyanate (including blocked (poly)isocyanate), primary amine, secondary amine, amide, carbamate, urea, urethane, vinyl, unsaturated ester, maleimide, fumarate, anhydride, hydroxyl alkylamide, epoxy, or combinations thereof.

Suitable curing agents (crosslinking agents) that may be used in the present invention comprise an aminoplast resin, a polyisocyanate, a blocked polyisocyanate, a polyepoxide, a polyacid, a polyol, or combinations thereof.

In certain embodiments, the second coating composition, when cured, is a low gloss coating. As used herein, “low gloss” means a value of less than 15 at 60° when measured by BYK-Gardner glossmeter (available from BYK-Gardner USA).

### Other Components:

In some embodiments, the first and/or second coating composition described can also comprise additional components other than those described above. For example, the first and/or second coating composition may comprise colorants and/or other optional materials, which are known in the art of formulated surface coatings. As used herein, the term “colorant” means any substance that imparts color and/or other opacity and/or other visual effect to the composition. The colorant can be added to the coating in any suitable form, such as discrete particles, dispersions, solutions and/or flakes (e.g., aluminum flakes). A single colorant or a mixture of two or more colorants can be used in the coating composition described herein.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which discreet “composite microparticles”, which comprise a nanoparticle and a resin coating on the nanoparticle, is dispersed. Example dispersions of resin-coated nanoparticles and methods for making them are identified in United States Patent Application Publication 2005/0287348, filed Jun. 24, 2004, U.S. Provisional Application No. 60/482,167 filed Jun. 24, 2003, and U.S. patent application Ser. No. 11/337,062, filed Jan. 20, 2006.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating composition described herein. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919, filed July 16, 2004.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, including phosphonic acids and other customary auxiliaries.

In addition to the materials described above, the coating compositions described herein can also be substantially free of organic solvent or, in some cases, completely free of organic solvent (e.g., butyl acetate, xylene or methyl ethyl ketone).

### Coating System

The coating compositions disclosed herein may be applied alone or as part of a coating system that can be deposited onto a number of different substrates. The coating system typically comprises a number of coating layers. A coating layer is typically formed when a coating composition that is deposited onto the substrate is substantially cured, dehydrated, and/or dried using methods known in the art (e.g., by thermal heating or via infrared radiation).

Suitable substrates that can be coated with the coating compositions disclosed herein include metal substrates, metal alloy substrates, and/or substrates that have been metallized, such as nickel plated plastic. In some embodiments, the metal or metal alloy can be aluminum and/or steel. For example, the steel substrate could be cold rolled steel, electrogalvanized steel, and hot dipped galvanized steel. Moreover, in some embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars, motorcycles, and trucks.

While the preceding paragraphs describe the coating system as comprising the first and second coating layer, in certain embodiments, a topcoating composition may be applied onto at least a portion of the second coating layer, which may comprise the residue of a polyester film forming polymer with an isocyanate curing agent. The topcoating compositions that may be used include a substantially clear coating composition (hereinafter, “clearcoat”). As used herein, a “substantially clear” coating composition is substantially transparent and not opaque when cured. In certain embodiments, the substantially clear coating composition can comprise a colorant but not in an amount such as to render the clear coating composition opaque (not substantially transparent) after it has been cured. Any clearcoat coating composition known in the art may be used in the present invention. For example, the clearcoat coating composition that is described in U.S. Pat. Nos. 5,989,642, 6,245,855, 6,387,519, and 7,005,472 can be used in the coating system. In certain embodiments, the substantially clear coating composition can also comprise a particle, such as a silica particle, that is dispersed in the clearcoat coating composition (such as at the surface of the clearcoat coating composition after curing).

In certain embodiments, no other coating is applied over the second coating composition.

The coating compositions that form the various coating layers described herein can be deposited or applied onto the substrate using any technique that is known in the art. For example, the coating compositions can be applied to the substrate by any of a variety of methods including, without limitation, spraying, electrostatic spraying, brushing, dipping (immersion), and/or roll coating, among other methods. For example, in certain embodiments, the first coating composition can be applied using the dipping technique. When a plurality of coating compositions are applied onto a substrate, it should be noted that one coating composition may be applied onto at least a portion of an underlying coating composition either after the underlying coating composition has been cured or prior to the underlying coating composition being cured. If the coating composition is applied onto an underlying coating composition that has not been cured, both coating compositions may be cured simultaneously.

The coating compositions may be cured using any technique known in the art such as, without limitation, thermal energy, infrared, ionizing or actinic radiation, or by any combination thereof. In certain embodiments, the curing operation can be carried out at temperatures ≧10° C. In other embodiments, the curing operation can be carried out at temperature ≦246° C. In certain embodiments, the curing operation can carried out at temperatures ranging between any combination of values, which were recited in the preceding sentences, inclusive of the recited values. For example, the curing operation can be carried out at temperatures ranging from 120° C.-150° C. It should be noted, however, that lower or higher temperatures may be used as necessary to activate the curing mechanisms.

In certain embodiments, one or more of the coating compositions described herein (e.g., clearcoat) is a low temperature, moisture curable coating compositions. As used herein, the term “low temperature, moisture curable” refers to coating compositions that, following application to a substrate, are capable of curing in the presence of ambient air, the air having a relative humidity of 10% to 100%, such as 25% to 80%, and a temperature in the range of −10° C. to 120° C., such as 5° C. to 80° C., in some cases 10° C. to 60° C. and, in yet other cases, 15° C. to 40° C.

The dry film thickness of the coating layers described herein can range from 0.1 micron to 500 microns. In other embodiments, the dry film thickness can be ≦125 microns, such as ≦80 microns. For example, the dry film thickness can range from 15 microns to 60 microns.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Example 1

### Preparation of a Zirconium Based Pretreatment Composition

The zirconium pretreatment solution was XBOND 4200DS (available from PPG Industries, Inc.).

### Example 2

### Preparation of Another Zirconium Based Pretreatment Composition

The zirconium pretreatment solution was XBOND 4200DM (available from PPG Industries, Inc.).

### Example 3

### Preparation of Another Zirconium Based Pretreatment Composition

The zirconium pretreatment solution was ZIRCOBOND 4200DS (available from PPG Industries, Inc.).

### Example 4

### Preparation of Another Zirconium Based Pretreatment Composition

The zirconium pretreatment solution was ZIRCOBOND 4200DM (available from PPG Industries, Inc.).

### Example 5

### Powder Coating Composition

Sixteen batches of 2500 grams shots were weighed up for a total of 40,000 grams of a material comprising of an ENVIROCRON product available from PPG Industries that was modified for color using a 31.44% increase in Printex G available from EVONIK Pigments, 57.46% increase in Tiona 595 available from Millennium Inorganics and a 24.57% decrease in Monolite Gray 860 from Canadian Industries. Each 2500 grams was premixed using a Henschel High Intensity Mixer. Then extruded with a Werner Pfleideres ZSK-30 with at the following zone temperatures, 40° C./40° C./40° C./80° C./120° C./120° C. The extrudate was poured onto chill rolls to form chip. The chip was then ground using an Mikro-ACM Air Classifying Mill—2 to obtain a particle size between 36-42 μm. The final powder was then weighed and 0.1% of Aluminum oxide C was hand shaken into the material.

Color-modified ENVIROCRON-MLP40000 Powder coating composition (available from PPG Industries, Inc.).

### Coated Substrates

### Preparation of Panels:

4″×12″ ACT CRS and 4″×12″ ACT C700/C59 steel panels (available from ACT Laboratories, Hillsdale, Mich.) were cleaned prior to being coated with Examples 1-4 with CHEMKLEEN 166 HP/171ALF, an alkaline cleaner, which is available from PPG Industries, Inc., and rinsed with deionized water prior to being pretreated with the pretreatment compositions of Examples 1-4.

### Coated Panels:

### Example A

Example 1 was used as the pretreatment composition. Example 1 was spray applied onto the steel panels for 120 seconds at 27° C. (80.6° F.). The panels were then rinsed with deionized water and dried for 5 minutes at 55° C. (131° F.) using forced air. Each panel was then coated with the powder composition of Example 5 via the use of a spray gun (Versa-Spray Manual Gun, Model #NDE-CC8, available from Nordson in Amherst, Ohio) at 75-85 Kv (kilovolts) in an amount sufficient to yield the cured film thickness depicted in Table 1 below. The powder coating composition was cured in a thermal oven (Model 74-900MM available from Precision Quincy Corporation, Woodstock, Ill.) for 20 minutes at 201.7° C. (395° F.).

### Example B

The method used for this Example is the same as that of Example A except that Example 2 was used as the pretreatment composition as opposed to Example 1 and the pretreatment was applied by immersion of steel panels for 120 seconds at 27° C. (80.6° F.).

### Example C

The method used for this Example is the same as that of Example A except that Example 3 was used as the pretreatment composition as opposed to Example 1.

### Examples D1-D3

The method used for these Examples is the same as that of Example A except that Example 4 was used as the pretreatment composition as opposed to Example 1 and the pretreatment was applied by immersion of steel panels for 120 seconds at 27° C. (80.6° F.). Additionally, as can be seen in Tables 1 and 2, the difference between Examples D1-D3 is the cured (dry) film thicknesses.

### Comparative Examples E1, E2, and E3

Some of the panels that were prepared via the method described in the “Preparation of panels” section above, were placed into a surface conditioner (Rinse Conditioner available from PPG Industries, Inc.), which was held at a temperature of 37.78° C. (100° F.), for a time period of 60 seconds, prior to pretreatment with a zinc phosphate based pretreatment composition. The zinc phosphate based pretreatment composition used in this Example was CHEMOFOS 700 (available from PPG Industries, Inc.), which was sprayed applied onto the panels at a temperature of 51.57° C. (125° F.) for 120 seconds. The panels were then rinsed with deionized water and then dried with a warm air blow off for 5 minutes at 55° C. (131° F.). The powder composition of Example 5 was then applied onto the panels as described in Example A to give the dry film thicknesses recited in Tables 1 and 2.

TABLE 1
Corrosion Performance

| | | Neutral Salt | Cathodic |
|---|---|---|---|
| | Cured (Dry) Film | Spray Test¹ | Delamination |
| Coated Panels | Thickness (mil) | (mm) | Test² (mm) |
| Example A | 2.0 | 2.8 | n/a |
| Example B | 2.0 | 2.1 | n/a |
| Example C | 2.0 | 3.7 | n/a |
| Example D1 | 0.5 | 3.8 | 3.7 |
| Example D2 | 1.0 | 2.4 | 4.6 |
| Example D3 | 2.0 | 2.2 | 3.7 |
| Comparative | 0.5 | 7.0 | 26.8 |
| Example E1 | | | |
| Comparative | 1.0 | 5.5 | 26.7 |
| Example E2 | | | |
| Comparative | 2.0 | 6.1 | 4.6 |
| Example E3 | | | |

¹400 Hour neutral salt spray test conducted via ASTM B-117 (2007)
²All non-coated areas of the panels that were prepared pursuant to Examples A, B, C, and D1-D3 as well as Comparative Examples E1, E2, and E3 were taped using vinyl electrical tape (available from 3M). A 2¾″ line was scribed in the center of the coated panel. The top of the panel was sanded and placed in a glass quart jar, along with the graphite anode, with enough electrolyte to cover the panel. The panel and graphite anode were then connected to a Kepco power supply while a Fluke 77 IV multimeter is used to insure that 10 (+/−0.2) mA are flowing through the circuit. The test was run for 24 hours. The panels were then dried and the non-adhering coating was removed. The scribe creep was then measured.

TABLE 2
Adhesion Performance

| | | | Exposed-60° C., |
|---|---|---|---|
| | Cured (Dry) Film | Ambient | condensing humidity |
| Coated Panels | Thickness (mil) | (psi) | (psi) |
| Example D1 | 0.5 | 348 | 381 |
| Example D2 | 1.0 | 797 | 650 |
| Example D3 | 2.0 | 767 | 614 |
| Comparative | 0.5 | 309 | 358 |
| Example E1 | | | |
| Comparative | 1.0 | 482 | 516 |
| Example E2 | | | |
| Comparative | 2.0 | 720 | 539 |
| Example E3 | | | |

Tables 1 and 2 depict the improved corrosion and mechanical properties of various embodiments of the present invention when compared to a coating system that comprises a first coating layer deposited from a coating composition comprising a zinc phosphate coating composition and a second layer comprising a powder coating composition. Specifically, as can be seen from Table 1, the coating system of the present invention demonstrated a scribe loss value of at least 2.4 mm less, when subjected to the Neutral Salt Spray Test, than that of a Comparative Examples E1-E3. That is, in certain embodiments, the coating system of the present invention, when subjected to the Neutral Salt Spray Test, demonstrates a scribe loss value of at least 2.4 mm less than that of a coating system that comprises a zinc phosphate coating layer onto which a powder coating layer has been deposited wherein the dry film thickness of the second coating layer and the powder coating layer is ≦2 mil. Table 1 also shows that the coating system of the present invention demonstrates a scribe loss value ranging from 2.2 mm to 3.8 mm when the dry film thickness of the second coating layer ranges from 2 mil down to 0.5 mil.

1. A coating system comprising:
a first coating layer deposited onto at least a portion of a substrate wherein said first coating layer is deposited from a first coating composition comprising a group IIIB metal compound, a group IVB metal compound, or combinations thereof; and
a second coating layer deposited onto at least a portion of the first coating layer wherein said second coating layer is deposited from a second coating composition comprising a powder coating composition.

2. The coating system of claim 1, wherein the powder coating composition comprises (a) a film forming polymer having a reactive functional group; and (b) a curing agent that is reactive with the functional group.

3. The coating system of claim 2, wherein the (a) film-forming polymer comprises a (poly)ester and the (b) curing agent comprises isocyanate.

4. The coating system of claim 2, wherein after cure of the second coating layer, the coating system demonstrates a scribe loss value of at least 2.4 mm less, when subjected to the Neutral Salt Spray Test, than that of a coating system in which the first coating layer does not comprise a group IIIB metal compound, a group IVB metal compound, or combinations thereof; and wherein the dry film thickness of the powder coating layer is ≦2 mil.

5. The coating system according to claim 1, wherein the first coating composition further comprises (ii) free fluorine and (iii) a metal fluoride salt formed from a metal which forms a fluoride salt; wherein the metal that forms the metal fluoride salt is present in an amount sufficient to maintain the level of free fluorine in the first coating composition at a level ranging from 0.1 ppm to 300 ppm based on the total weight of the first coating composition.

6. The coating system according to claim 1, wherein the group IIIB or IVB metal comprises zirconium, titanium, hafnium, yttrium, cerium, or combinations thereof.

7. The coating system according to claim 1, wherein the first coating composition is substantially free of phosphate ions.

8. A coating system comprising:
a first coating layer deposited onto at least a portion of a substrate wherein said first coating layer is deposited from a first coating composition comprising a group IIIB metal compound, a group IVB metal compound, or combinations thereof; and
a second coating layer deposited onto at least a portion of the first coating layer wherein said second coating layer is deposited from a second coating composition comprising a powder coating composition; and
wherein the coating system demonstrates a scribe loss value of at least 2.4 mm less, when subjected to the Neutral Salt Spray Test, than that of a coating system in which the first coating layer does not comprise a group IIIB metal compound, a group IVB metal compound, or combinations thereof; and wherein the dry film thickness of the powder coating layer is ≦2 mil.

9. A method of coating a substrate comprising:
depositing a first coating composition onto at least a portion of the substrate, said first coating composition comprising: a group IIIB metal compound, a group IVB metal compound, or combinations thereof;
optionally, rinsing at least a portion of the first coating composition with a rinsing solution; and
depositing a second coating composition onto at least a portion of the first coating composition, said second coating composition comprising a powder coating composition.

10. The method according to claim 9, wherein the powder coating composition comprises (a) a film forming polymer having a reactive functional group; and (b) a curing agent that is reactive with the functional group.

11. The method according to claim 9, wherein the (a) film forming polymer comprises a (poly)ester.

12. The method according to claim 9, wherein the (b) curing agent comprises isocyanate.

13. The method according to claim 9, wherein the first coating composition further comprises (ii) free fluorine and (iii) a metal fluoride salt formed from a metal which forms a fluoride salt; wherein the metal that forms the metal fluoride salt is supplied in an amount sufficient to maintain the level of free fluorine in the first coating composition at a level ranging from 0.1 ppm to 300 ppm based on the total weight of the first coating composition.

14. The method according to claim 9, wherein the group IIIB or IVB metal comprises zirconium, titanium, hafnium, yttrium, cerium, or combinations thereof.

15. The method according to claim 9, wherein the first coating composition is substantially free of phosphate ions.

16. The method according to claim 9, further comprising curing at least a portion of the second coating after it is deposited onto the first coating composition.

17. A substrate coated with the coating system of claim 1.
